(19) United States
(12) Patent Application Publication
(10) Pub. No.: US 2021/0409631 A1
(43) Pub. Date: Dec. 30, 2021

(54) IMAGE SENSOR

(71) Applicant: SK hynix Inc., Gyeonggi-do (KR)

(72) Inventor: Eun Jun KIM, Gyeonggi-do (KR)

(21) Appl. No.: 17/343,977

(22) Filed: Jun. 10, 2021

(30) Foreign Application Priority Data
Jun. 25, 2020 (KR) 10-2020-0077677

(51) Int. Cl. H04N 5/359; H04N 5/378; H04N 5/374

(52) U.S. Cl. CPC H04N 5/3595; H04N 5/374; H04N 5/378

(57) ABSTRACT

An image sensor comprises a pixel array including a plurality of pixels where a plurality of columns and a plurality of rows are arranged, a read-out circuit generating image data using pixel signals output from pixels corresponding to a row selected from among the plurality of rows, and a plurality of gain adjustment lines provided for every plurality of columns and adjusting gains of pixels of their respective corresponding columns.

### CROSS-REFERENCE TO RELATED APPLICATION

The present application claims priority under 35 U.S.C. § 119 to Korean Patent Application No. 10-2020-0077677, filed on Jun. 25, 2020, which is herein incorporated by reference in its entirety.

### BACKGROUND

### 1. Field

The disclosure relates to image sensors.

### 2. Description of the Related Art

Unlike solid-state image sensing devices, complementary metal oxide semiconductor (CMOS) image sensors (CISs) require conversion of analog signals (i.e., pixel signals) output from a pixel array to digital signals. For such analog-to-digital signal conversion, CMOS image sensors include a high-resolution analog-to-digital converter (ADC).

According to implementation of the ADC, there are two types of CISs: one using a single ADC and the other using a column ADC.

The single ADC type CIS converts the analog signals output from the pixels of all the columns to digital signals within a set time. This type CIS may advantageously have a reduced chip area for the CIS but may consume significant power due to the need for the ADC to operate at high speed.

The column ADC type has a simplified ADC (e.g., a single-slope ADC) placed at each column and thus has the drawback of increasing chip area of CIS. However, since each ADC may operate at low speed, power consumption may be reduced.

Currently, most CISs adopt a column analog-to-digital conversion scheme that operates to achieve optimal trade-off between speed and power. If the column analog-to-digital conversion scheme is used, several columns of a selected row are simultaneously read out and, thus, the pixel signals from adjacent columns may influence each other, causing banding noise.

### SUMMARY

Embodiments of the disclosure provide technology for reducing banding noise in image sensors.

According to an embodiment, an image sensor comprises a pixel array including a plurality of pixels arranged in a plurality of columns and a plurality of rows; a read-out circuit generating image data using pixel signals output from pixels corresponding to a row selected from among the plurality of rows; and a plurality of gain adjustment lines provided for the plurality of columns, respectively, each gain adjustment line adjusting gains of pixels of the corresponding column.

According to an embodiment, an image sensor comprises a pixel array including a plurality of pixels, a read-out circuit generating image data using pixel signals output from pixels selected from among the plurality of pixels, and a plurality of gain adjustment lines separated from each other to adjust a gain of each of the selected pixels.

According to an embodiment, a pixel array including a plurality of pixels arranged in a plurality of rows and a plurality of columns, each pixel including at least one transistor and a capacitor, which are coupled to a floating diffusion node; a plurality of signal lines, each signal line coupled to pixels in a corresponding row and configured to provide one or more signals to transistors of the pixels in the corresponding row; a plurality of gain adjustment lines, each gain adjustment line coupled to pixels in a corresponding column and configured to control capacitors of the pixels in the corresponding column; and a read-out circuit configured to receive pixel signals from pixels in a row selected from among the plurality of rows, and convert the pixel signals to generate image data.

According to various embodiments of the disclosure, banding noise in the image sensor may be reduced.

### BRIEF DESCRIPTION OF THE DRAWINGS

FIG. 1 is a diagram illustrating a pixel array according to an embodiment of the disclosure;

FIG. 2 is a diagram illustrating a phenomenon in which banding noise occurs in a pixel array, such as that of FIG. 1;

FIG. 3 is a diagram illustrating a pixel array according to an embodiment of the disclosure; and

FIG. 4 is a diagram illustrating a configuration of an image sensor including a pixel array, such as that of FIG. 3.

### DETAILED DESCRIPTION

Embodiments of the disclosure are described below in detail with reference to the accompanying drawings to enable one skilled in the art to practice the present invention. Well known material not directly related to the subject matter of the disclosure may be omitted for clarity. Like reference notations are used to identify like elements throughout the specification and the drawings. Also, throughout the specification, reference to “an embodiment” or the like is not necessarily to only one embodiment, and different references to any such phrase are not necessarily to the same embodiment(s). The term “embodiments” when used herein does not necessarily refer to all embodiments.

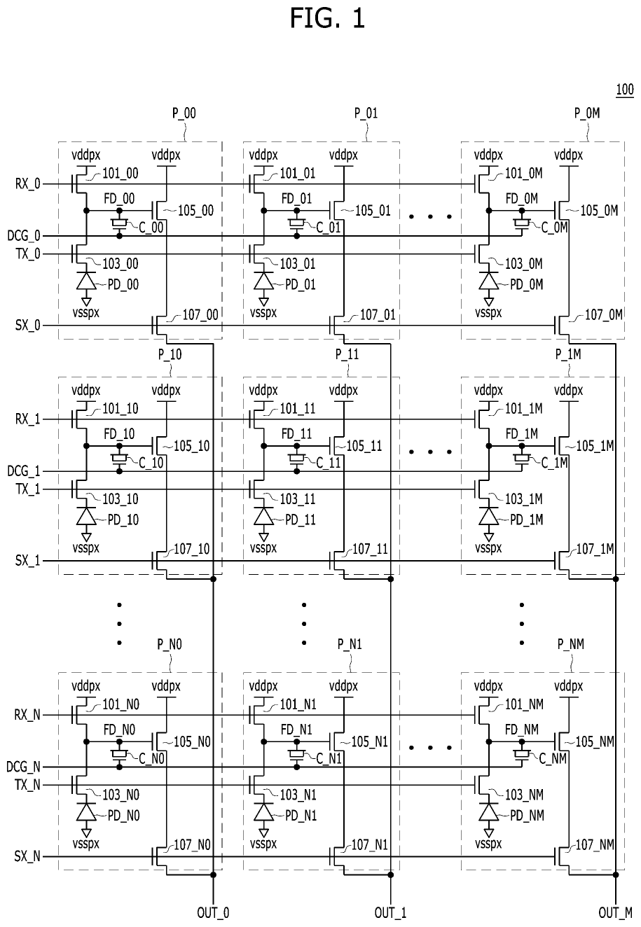

FIG. 1 is a diagram illustrating a pixel array 100 according to an embodiment of the disclosure.

Referring to FIG. 1, the pixel array 100 may include a plurality of pixels P_00 to P_NM that are arranged in a plurality of rows and a plurality of columns. To control the operation of the plurality of pixels P_00 to P_NM and output pixel signals, lines RX_0 to RX_N, TX_0 to TX_N, SX_0 to SX_N, and DCG_0 to DCG_N are arranged in a row direction and lines OUT_0 to OUT_M are arranged in a column direction.

Reset signal lines RX_0 to RX_N may be formed separately for each row and may control the reset operation of the pixels of their respective corresponding rows. For example, a reset signal line RX_1 may control the reset operation of the pixels P_10 to P_1M in a first row.

Transfer signal lines TX_0 to TX_N may be formed separately for each row and may control the transfer operation of the pixels of their respective corresponding rows. For example, a transfer signal line TX_0 may control the transfer operation of the pixels P_00 to P_0M in a zeroth row.

Selection signal lines SX_0 to SX_N may be formed separately for each row and may control the output operation of the pixels of their respective corresponding rows. For example, a selection signal line SX_2 may control the output operation of the pixels P_20 to P_2M in a second row.

Gain adjustment lines DCG_0 to DCG_N may be formed separately for each row and may control the gain of the pixels of their respective corresponding rows. For example, a gain adjustment line DCG_N may adjust the gain of the pixels P_N0 to P_NM in an Nth row.

Pixel output lines OUT_0 to OUT_M may be formed separately for each column and be used to output the pixel signals of the pixels of their respective corresponding columns. For example, the pixel signal of a pixel selected from among the pixels P_30 to P_3N in a third column may be output through a pixel output line OUT_3.

Each of the pixels P_00 to P_NM may include a light detector PD_00 to PD_NM, a floating diffusion node FD_00 to FD_NM, a reset transistor 101_00 to 101_NM a transfer transistor 103_00 to 103_NM, a driving transistor 105_00 to 105_NM, a selection transistor 107_00 to 107_NM, and a capacitor C_00 to C_NM.

The light detector PD_00 to PD_NM may perform a photoelectric conversion function. The light detector PD_00 to PD_NM may be connected between the ground voltage terminal vsspx and the transfer transistor 103_00 to 103_NM. The light detector PD_00 to PD_NM may receive light from the outside and generate photo charge based on the received light. The light detector PD_00 to PD_NM may be implemented using at least any one of a photo diode, a photo transistor, a photo gate, a pinned photo diode, and a combination thereof.

The reset transistor 101_00 to 101_NM may transfer a source voltage vddpx to the floating diffusion node FD_00 to FD_NM in response to the reset signal transferred to its corresponding reset signal line among the reset signal lines RX_0 to RX_N. In other words, the reset transistor 101_00 to 101_NM may reset the photo charge stored in the floating diffusion node FD_00 to FD_NM in response to the voltage of its corresponding reset signal line.

The transfer transistor 103_00 to 103_NM may transfer the photo charge of the light detector PD_00 to PD_NM to the floating diffusion node FD_00 to FD_NM in response to the transfer signal transferred to its corresponding transfer signal line among the transfer signal lines TX_0 to TX_N. The floating diffusion node FD_00 to FDNM is a diffusion area connected to the transfer transistor 103_00 to 103_NM and the reset transistor 101_00 to 101_NM and is a node where the electric charge corresponding to an image signal or the electric charge corresponding to an initialization voltage is accumulated.

The driving transistor 105_00 to 105_NM may have a gate connected to the floating diffusion node FD_00 to FD_NM and a drain and source connected between the source voltage terminal vddpx and the selection transistor 107_00 to 107_NM. The driving transistor 105_00 to 105_NM may amplify the voltage of the floating diffusion node FD_00 to FD_NM.

The selection transistor 107_00 to 107_NM may transfer the voltage, i.e., pixel signal, amplified by the driving transistor 105_00 to 105_NM, to its corresponding pixel output line among the pixel output lines OUT_0 to OUT_M in response to a selection signal transferred to its corresponding selection signal line among the selection signal lines SX_0 to SX_N.

The capacitor C_00 to C_NM may be connected to the floating diffusion node FD_00 to FD_NM and its capacitance may be adjusted in response to the voltage of its corresponding gain adjustment line among the gain adjustment lines DCG_0 to DCG_N. The capacitor C_00 to C_NM may be configured as a metal-oxide- semiconductor (MOS) transistor, and its capacitance may increase as the voltage of its corresponding gain adjustment line increases. Since the capacitance of the floating diffusion node FD_00 to FD_NM is adjusted according to the capacitance of the capacitor C_00 to C_NM, pixel conversion gain may be adjusted. Such gain adjusting function is called a dual conversion gain (DCG) function.

The read-out operation of generating image data by analog-to-digital conversion of the pixel signals from the pixel array 100 may be performed for each row. For example, the read-out operation of the pixels P_00 to P_0M in the zeroth row may be simultaneously performed, and the read-out operation of the pixels P_10 to P_1M in the first row may be simultaneously performed.

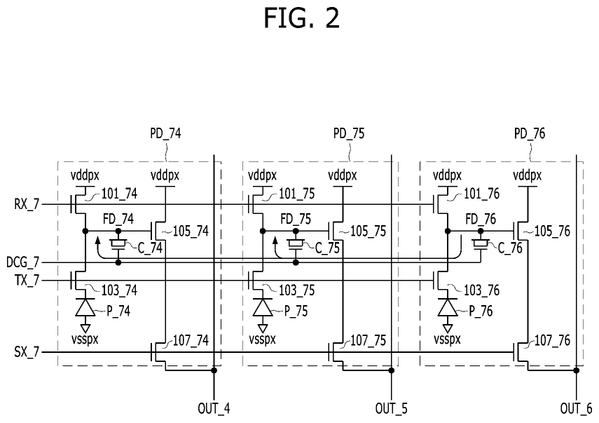

FIG. 2 is a diagram illustrating a phenomenon in which banding noise occurs in the pixel array 100 of FIG. 1. It is hypothesized that the read-out operation of the pixels P_70 to P_7M at the seventh row is being performed. By way of example, only three pixels P_74, P_75, and P_76 of the 70th row are illustrated in FIG. 2, It is assumed that the pixel P_76 detects bright light, and the pixels P74 and P75 detect dark light.

When the electric charge of the light detectors PD_74, PD_75 and PD_76 are transferred to the floating diffusion nodes FD_74, FD_75 and FD_76, the floating diffusion node FD_76 of the pixel P_76 detecting the bright light may experience more variations in voltage level than the floating diffusion nodes FD_74 and FD_75 of other pixels P_74 and P_75. A significant variation in voltage level of the floating diffusion node FD_76 may influence the floating diffusion nodes FD_74 and FD_75 via the capacitor C_76, gain adjustment line DCG_7, and capacitors C_74 and C_75, resultantly altering the voltage level of the floating diffusion nodes FD_74 and FD_75. In other words, the signal of the pixel P_76 detecting bright light may affect the signals of the pixels P_74 and P_75 detecting dark light. Resultantly, banding noise may occur, causing an image to be generated as if brighter light has been detected than the actual light detected by the pixels P_74 and P_75.

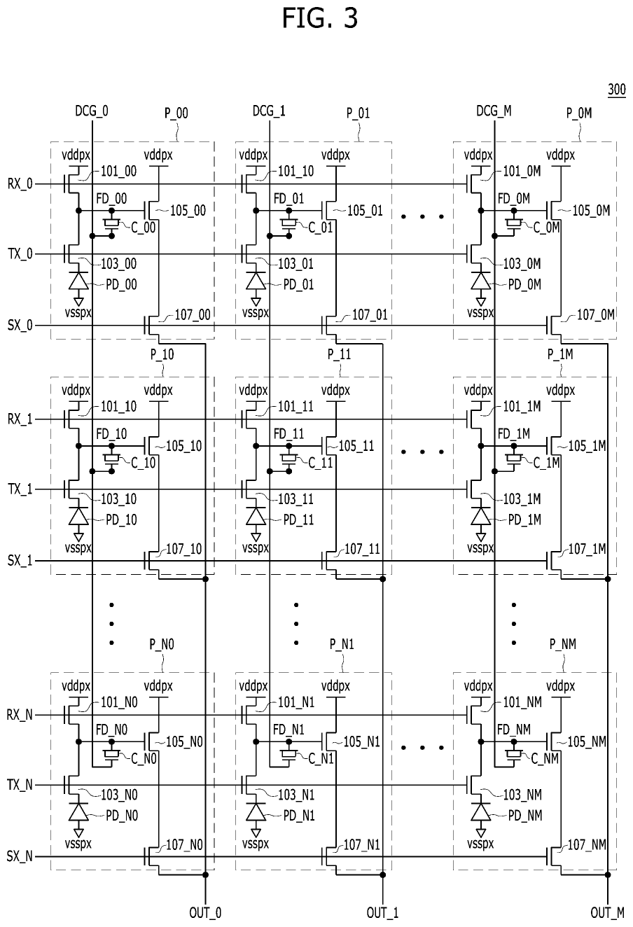

FIG. 3 is a diagram illustrating a pixel array 300 according to an embodiment of the disclosure.

Referring to FIG. 3, the pixel array 300 may include a plurality of pixels P_00 to P_NM that are arranged in a plurality of rows and a plurality of columns. To control the operation of the plurality of pixels P_00 to P_NM and output pixel signals, lines RX_0 to RX_N, TX_0 to TX_N, and SX_0 to SX_N are arranged in a row direction and lines DCG_0 to DCG_M and OUT_0 to OUT_M are arranged in a column direction.

Unlike the pixel array 100 of FIG. 1, in the pixel array 300, the gain adjustment lines DCG_0 to DCG_M may be arranged in the column direction. The gain adjustment lines DCG_0 to DCG_M may be provided for each column and adjust the gain of the pixels of their respective corresponding columns. For example, a gain adjustment line DCG_9 may adjust the gain of the pixels P_09 to PN9 in a ninth column.

When the gain adjustment lines DCG_0 to DCG_M are provided independently for each column, this means that the gain adjustment lines corresponding to the pixels simultaneously read out are independent from each other. For example, when the pixels P30 to P3M in a third row are simultaneously read out, the pixels P30 to P3M all may be connected to the DCG_0 to DCG_M separated from each other. Since the gain adjustment lines corresponding to the pixels simultaneously read out are independent from each other, banding noise may be prevented which would otherwise occur as the floating diffusion nodes FD_74, FD_75, and FD_76 influence each other via the gain adjustment line DCG_7 as shown in FIG. 2.

Where the gain adjustment lines DCG_0 to DCG_M are formed in the column direction, the pixels of the same column may share the same gain adjustment line. Since the pixels of the same column are read out at different times, rather than simultaneously, banding noise may be avoided via the gain adjustment lines DCG_0 to DCG_M in such a case.

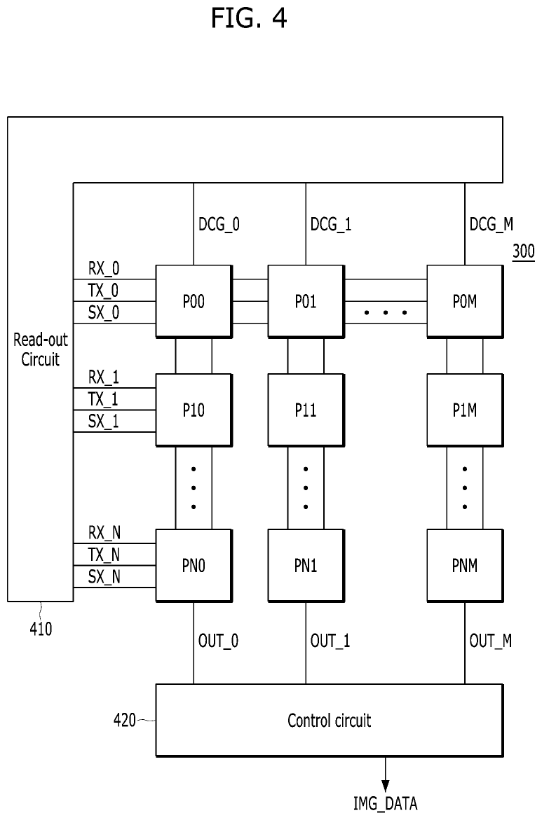

FIG. 4 is a diagram illustrating a configuration of an image sensor including the pixel array 300 of FIG. 3.

Referring to FIG. 4, the image sensor may include the pixel array 300, lines RX_0 to RX_N, TX_0 to TX_N, SX_0 to SX_N in a row direction, lines DCG_0 to DCG_M, OUT_0 to OUT_M in a column direction, a control circuit 410, and a read-out circuit 420.

The pixel array 300 may include a plurality of pixels P_00 to P_NM that are arranged in a plurality of rows and a plurality of columns.

Reset signal lines RX_0 to RX_N arranged in the row direction may control the reset operation of the pixels of their respective corresponding rows. Transfer signal lines TX_0 to TX_N may control the transfer operation of the pixels of their respective corresponding rows. Selection signal lines SX_0 to SX_N may control the output operation of the pixels of their respective corresponding rows.

Gain adjustment lines DCG_0 to DCG_M arranged in the column direction may control the gain of the pixels of their respective corresponding columns. Pixel output lines OUT_0 to OUT_M may be used to output the pixel signals of the pixels of their respective corresponding columns. Since the gain adjustment lines DCG_0 to DCG_M may be provided independently for each column, banding noise may be suppressed.

The control circuit 410 may generate signals transferred to the lines RX_0 to RX_N, TX_0 to SX_0 to DCG_0 to DCG_M for controlling the pixels P_00 to P_NM. In particular, the control circuit 410 may control the voltages of the gain adjustment lines DCG_0 to DCG_M, provided for each column, independently for each column. In other words, upon read-out operation, the gains of the pixels of different columns may differ from each other. All the columns may be controlled to have the same gain.

The read-out circuit 420 may generate image data IMG_DATA using the pixel signals output via the pixel output lines OUT_0 to OUT_M from the pixels corresponding to a row selected from among the plurality of rows of the pixel array. The read-out circuit 420 may include circuitry for generating the image data IMG_DATA by analog-to-digital conversion of the pixel signals.

It should be noted that, although embodiments of the present invention have been illustrated and described, this is merely for purpose of example, not to limit the scope of the invention. Those skilled in the art will understand in view of the present disclosure that various changes may be made to any of the disclosed embodiments without departing from the technical spirit of the disclosure. The present invention encompasses all such changes that fall within the scope of the claims.

What is claimed is:

1. An image sensor, comprising:
a pixel array including a plurality of pixels arranged in a plurality of columns and a plurality of rows;
a read-out circuit generating image data using pixel signals output from pixels corresponding to a row selected from among the plurality of rows; and
a plurality of gain adjustment lines provided for the plurality of columns, respectively, each gain adjustment line adjusting gains of pixels of the corresponding column.

2. The image sensor of claim 1, further comprising:
a plurality of reset signal lines provided for the plurality of rows, respectively, each reset signal line controlling a reset operation of pixels of the corresponding row;
a plurality of transfer signal lines provided for the plurality of rows, respectively, each transfer signal line controlling a transfer operation of pixels of the corresponding row;
a plurality of selection signal lines provided for the plurality of rows, respectively, each selection signal line controlling an output operation of pixels of the corresponding row; and
a plurality of pixel output lines provided for the plurality of columns, respectively, each pixel output line transferring pixel signals of pixels of the corresponding column to the read-out circuit.

3. The image sensor of claim 2, further comprising a control circuit for generating signals transferred to the plurality of gain adjustment lines, the plurality of reset signal lines, the plurality of transfer signal lines, and the plurality of selection signal lines.

4. The image sensor of claim 1,
wherein each of the plurality of pixels includes:
a light detector;
a floating diffusion node;
a reset transistor for resetting the floating diffusion node in response to the corresponding reset signal line among the plurality of reset signal lines;
is a transfer transistor for transferring electric charge from the light detector to the floating diffusion node in response to the corresponding transfer signal line among the plurality of transfer signal lines;
a driving transistor for amplifying a voltage of the floating diffusion node;
a selection transistor for transferring a voltage amplified by the driving transistor to the corresponding pixel output line among the plurality of pixel output lines, in response to the corresponding selection signal line among the plurality of selection signal lines; and
a capacitor connected to the floating diffusion node, wherein a capacitance of the capacitor is adjusted in response to the corresponding gain adjustment line among the plurality of gain adjustment lines.

5. The image sensor of claim 1,
wherein each of the plurality of pixels includes:
a floating diffusion node; and
a capacitor connected to the floating diffusion node, wherein a capacitance of the capacitor is adjusted in response to the corresponding gain adjustment line among the plurality of gain adjustment lines.

6. The image sensor of claim 4,
wherein the capacitor includes a metal oxide semiconductor transistor.

7. An image sensor, comprising:
a pixel array including a plurality of pixels;
a read-out circuit generating image data using pixel signals output from pixels selected from among the plurality of pixels; and
a plurality of gain adjustment lines separated from each other to adjust a gain of each of the selected pixels.

8. The image sensor of claim 7,
wherein each of the plurality of pixels includes:
a floating diffusion node; and
a capacitor connected to the floating diffusion node, wherein a capacitance of the capacitor is adjusted in response to the corresponding gain adjustment line among the plurality of gain adjustment lines.

9. The image sensor of claim 7,
wherein each of the plurality of pixels includes:
a light detector;
a floating diffusion node;
a reset transistor for resetting the floating diffusion node in response to a reset signal;
a transfer transistor for transferring electric charge from the light detector to the floating diffusion node in response to a transfer signal;
a driving transistor for amplifying a voltage of the floating diffusion node;
a selection transistor for transferring a voltage amplified by the driving transistor to the read-out circuit in response to a selection signal; and
a capacitor connected to the floating diffusion node, wherein a capacitance of the capacitor is adjusted in response to the corresponding gain adjustment line among the plurality of gain adjustment lines.

10. The image sensor of claim 7,
wherein the capacitor includes a metal oxide semiconductor transistor.

11. An image sensor comprising:
a pixel array including a plurality of pixels arranged in a plurality of rows and a plurality of columns, each pixel including at least one transistor and a capacitor, which are coupled to a floating diffusion node;
a plurality of signal lines, each signal line coupled to pixels in a corresponding row and configured to provide one or more signals to transistors of the pixels in the corresponding row;
a plurality of gain adjustment lines, each gain adjustment line coupled to pixels in a corresponding column and configured to control capacitors of the pixels in the corresponding column; and
a read-out circuit configured to receive pixel signals from pixels in a row selected from among the plurality of rows, and convert the pixel signals to generate image data.
